(19) United States
(12) Patent Application Publication
(10) Pub. No.: US 2018/0172422 A1
(43) Pub. Date: Jun. 21, 2018

(54) DEVICE FOR DETECTING THICKNESS AND THICKNESS VARIATION OF A SHEETLIKE OBJECT

(71) Applicant: Climax Machine Industry Co., Ltd, New Taipei City (TW)

(72) Inventors: Tien-Lu Hsu, New Taipei City (TW); Chun-Yen Chen, New Taipei City (TW); Po-Chia Jo, New Taipei City (TW)

(21) Appl. No.: 15/415,411

(22) Filed: Jan. 25, 2017

(30) Foreign Application Priority Data
Dec. 16, 2016 (TW) 105141838

(51) Int. Cl. G01B 7/06

(52) U.S. Cl. CPC G01B 7/10

(57) ABSTRACT

A device for detecting thickness and thickness variation of a sheetlike object, includes at least a first guiding component and a plurality of second guiding components, deviation between the first guiding component and the second guiding components occurs while the sheetlike object passed through among the first guiding component and those second guiding components; a elastic member, having a first elastic displacement end, a second elastic displacement end and a elastic member fixed surface, both of the first elastic displacement end and the second elastic displacement have a plane disposed thereto and served to connect with each side of a movable elastic member, while the elastic member fixed surface is to fix the elastic member; and a displacement sensor is configured to detect a displacement of a side face on the first elastic displacement end. The present invention has the ability to raise the accuracy of the thickness and thickness variation detection.

### CROSS-REFERENCE TO RELATED APPLICATIONS

This Non-provisional application claims priority under 35 U.S.C. § 119(a) on Patent Application No(s). 105141838 filed in Taiwan, Republic of China Dec. 16, 2016, the entire contents of which are hereby incorporated by reference.

### FIELD OF THE INVENTION

The present invention is related to a device for detecting thickness and thickness variation, especially related to a device for measuring the thickness or thickness variation of a sheetlike object, such as bill, paper, sheet or bank notes, bank securities, checks, stocks, paper with security signs, certificates, access cards or tickets, lotteries, and also including credit cards, bank automatic teller cards or ID cards or identification cards.

### BACKGROUND OF THE INVENTION

Generally, the thickness detection of banknotes is a necessary function in the money detecting apparatus and the ATM apparatus, and the tape, corners on the banknotes can be used to identify the thickness of the banknotes therefore recognize the unqualified banknotes.

The most commonly used repair method of a sheet, such as paper, bank notes, etc., is to reattach a layer of material for reinforcement. For example, the broken banknotes are usually using transparent tape to paste to avoid the continuously damage. As the banknotes will go through the recovery process, so the bank would spend lots of time and money developing device for identifying the accuracy of the tape on the banknotes.

The device for measuring the thickness variations caused by adhesive tapes must have a high degree of resolution to determine the thickness variations since the typical thickness of adhesive tapes is very small.

There are many methods for measuring the thickness variations caused by adhesive tapes, which can be divided into two types: non-contact type method and contact type method. In the non-contact portion, ultrasound (U.S. Pat. No. 4,446,735 and U.S. Pat. No. 7,748,274) or capacitive sensing (U.S. Pat. No. 8,028,990) are the most common methods. However, both methods are susceptible to non-banknote factors, such as mechanical high-frequency or humidity. Thus, people prefer to use the contact type method for measuring the thickness variations caused by adhesive tapes.

The contact type method can be divided into friction type and roller type. The friction type method, such as U.S. Pat. No. 8,651,481, and then using the piezoelectric element to output the signal. The roller-type method can be said to be presently the main design direction, such as U.S. Pat. No. 4,550,252, U.S. Pat. No. 4,693,010, U.S. Pat. No. 6,913,260, U.S. Pat. No. 7,743,523, U.S. Pat. No. 8,091,889, U.S. Pat. No. 8,496,246, and U.S. Pat. No. 8,582,123, U.S. Pat. No. 8,610,441. These patents are using rollers, and contact the objects then measured the thickness variations and represent the value on the wheel displacement; the roller would generate a rotational displacement due to the limitation of external rotation axis. The different patents are using different sensing elements to output the thickness variations signals.

In the constraint condition of the rotation axis of a link mechanism, the roller-type thickness variation detector would generate a rotational displacement (angular movement) in existing devices. Without adding any mechanical components, such as connecting rods, the side face, signal measuring items (such as metal plate) and the detecting components would generate a relative rotational displacement (angular displacement) and cannot generate a completely parallel or vertical displacement, so as to decrease the detection accuracy of the displacement detector.

For example, the device for detecting thickness and thickness variation of existing device 100′ (please refer to FIG. 1 and FIG. 2, which is a schematic diagram of U.S. Pat. No. 8,496,246). which is used for detecting thickness and thickness variation of a sheetlike object 200′, includes: at least a first guiding component 1′ and a plurality of second guiding components 2′, wherein the second guiding components 2′ are opposite of first guiding component 1′, and the second guiding components 2′ are arranged in line, a deviation between the first guiding component 1′ and the second guiding components occurs while the sheetlike object 200 passed through the first guiding component 1′ and those second guiding components 2′, due to the thickness variation of the sheetlike object 200′; a elastic member 3′, having a side face 35′ which is connecting with a movable elastic member 34′ through the second elastic displacement 32′, and the elastic member 3′, the side face 35′, movable elastic member 34′ and the second guiding component 2′ are connected and fixed with a stable fixed component 5′ through a rotation axis 51′; through a first elastic displacement end 31′, and the and the is connected with a movable elastic member 33′, both of the first elastic displacement end 31′ and have a plane disposed thereto and served to connect with each side of a while the elastic member fixed surface 33 is to fix the elastic member 3; and a displacement sensor 4 is configured to detect a displacement of a on the first elastic displacement end 31, and the displacement sensor 4 is located in a fixed place, wherein the first elastic displacement end 31 and the second elastic displacement end 32 go upside and downside deviation relative to the second guiding components 2; wherein the movable elastic member 34 is used for fixing the first elastic displacement end 31, so as to keep the shape of the side face 35 without bending or inclined deformation, the side face 35 is having a parallel displacement relative to the first elastic displacement end 31, and the side face 35 is having a parallel displacement relative to the displacement sensor 4 without any angular displacement.

Accordingly, how to develop a device for evaluating the displacement measuring accuracy without any angular displacement or inclined displacement is an urgent problem in relevant field.

### SUMMARY OF THE INVENTION

### Technical Problem to be Solved

In the constraint condition of the rotation axis of a link mechanism, the roller-type thickness variation detector would generate a rotational displacement (angular movement) in the money detector apparatus or in an ATM apparatus. The side face, signal measuring items (such as metal plate) and the detecting components would generate a relative rotational displacement (angular displacement) and cannot generate a completely parallel or vertical displacement, so as to decrease the detection accuracy of the displacement detector. Thus, the detection accuracy is an urgent problem in the relevant technical fields.

### Technical Means to Take

Accordingly, one object of the present invention is to provide A device for detecting thickness and thickness variation of a sheetlike object, includes: at least a first guiding component and a plurality of second guiding components, wherein the second guiding components are opposite of first guiding component, and the second guiding components are arranged in line, a deviation between the first guiding component and the second guiding components occurs while the sheetlike object passed through the first guiding component and those second guiding components, due to the thickness variation of the sheetlike object; a elastic member, having a first elastic displacement end, a second elastic displacement end and a elastic member fixed surface, both of the first elastic displacement end and the second elastic displacement have a plane disposed thereto and served to connect with each side of a movable elastic member, while the elastic member fixed surface is to fix the elastic member; and a displacement sensor is configured to detect a displacement of a side face on the first elastic displacement end, and the displacement sensor is located in a fixed place, wherein the first elastic displacement end and the second elastic displacement end go upside and downside deviation relative to the second guiding components; wherein the movable elastic member is used for fixing the first elastic displacement end, so as to keep the shape of the side face without bending or inclined deformation, the side face is having a parallel displacement relative to the displacement sensor without any angular displacement.

### Efficacy Achievement

The present invention provides a connected guiding components through a elastic member rather than using a rotation shaft to keep the shape of side face without bending or inclined deformation, so as that the side face could have a parallel displacement relative to the displacement sensor without any angular displacement. The traditional roller-type thickness variation detector would generate a rotational displacement (angular movement) in the money detector apparatus or in an ATM apparatus. The side face, signal measuring items (such as metal plate) and the detecting components would generate a relative rotational displacement (angular displacement). The present invention provides a side face for parallel displacement to evaluate the accuracy of thickness detection and thickness variation detection, to solve the problem of the prior art.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

### BRIEF DESCRIPTION OF THE DRAWINGS

FIG. 1 shows the schematic diagram of the device for detecting thickness and thickness variation of prior art.

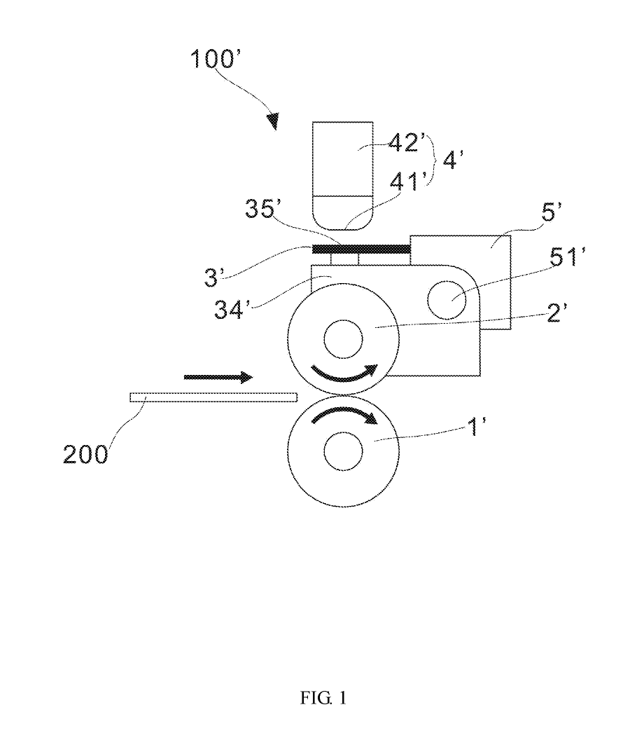

FIG. 2 shows another schematic diagram of the device for detecting thickness and thickness variation of prior art.

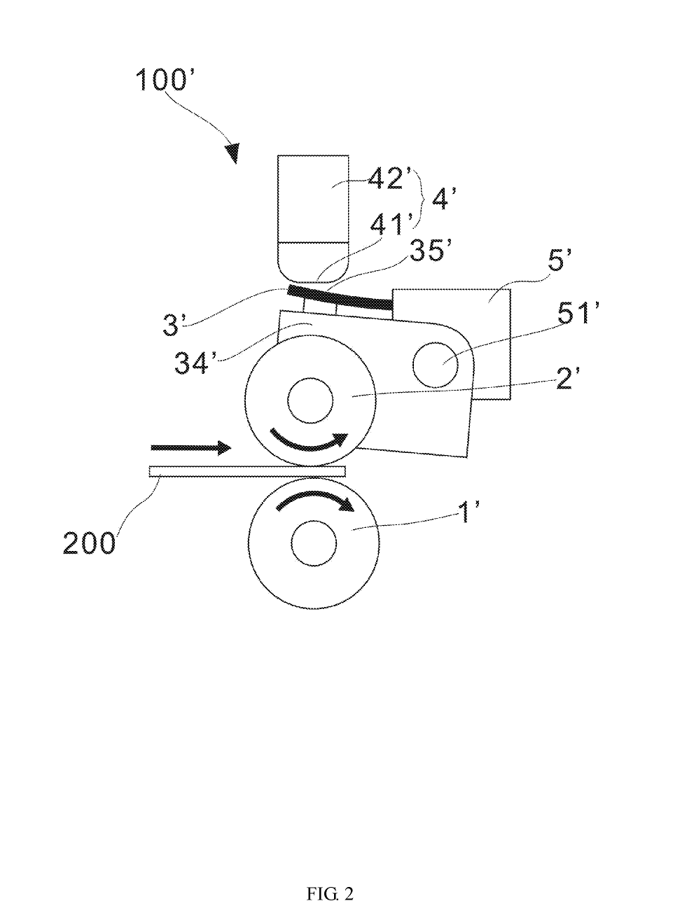

FIG. 3 shows the schematic diagram of the device for detecting thickness and thickness variation of the first example.

FIG. 4 shows another schematic diagram of the device for detecting thickness and thickness variation of the first example.

FIG. 5 shows the schematic diagram of the device for detecting thickness and thickness variation of the second example.

FIG. 6 shows another schematic diagram of the device for detecting thickness and thickness variation of the second example.

### DETAILED DESCRIPTION OF THE INVENTION

The following descriptive embodiments and the corresponding figures and symbols in the embodiments are illustrative description for the examiners of USPTO and the persons skilled in the art to understand the spirit of the present invention completely.

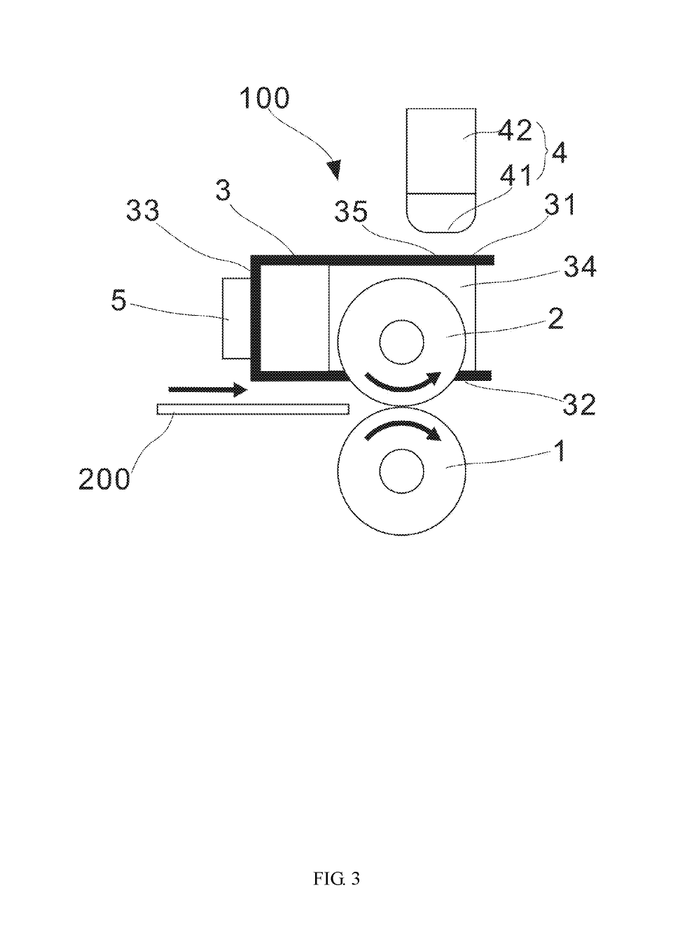

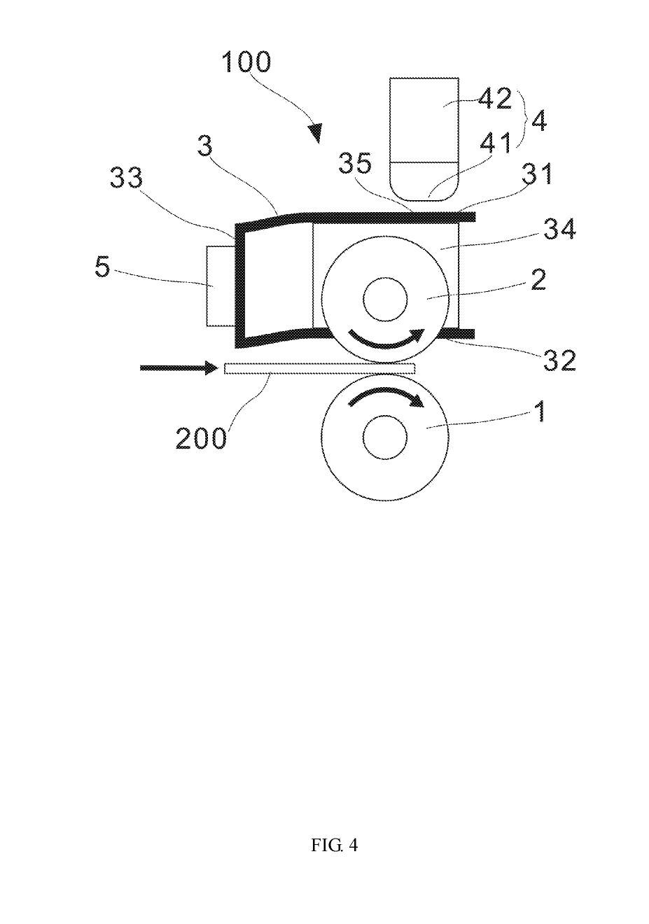

The first example of the present invention was shown in FIG. 3 and FIG. 4, which showed a device 100 for detecting thickness and thickness variation of a sheetlike object 200, includes: at least a first guiding component 1 and a plurality of second guiding components 2, wherein the second guiding components 2 are opposite of first guiding component 1, and the second guiding components 2 are arranged in line, a deviation between the first guiding component 1 and the second guiding components occurs while the sheetlike object 200 passed through the first guiding component 1 and those second guiding components 2, due to the thickness variation of the sheetlike object 200; a elastic member 3, having a first elastic displacement end 31, a second elastic displacement end 32 and a elastic member fixed surface 33, both of the first elastic displacement end 31 and the second elastic displacement 32 have a plane disposed thereto and served to connect with each side of a movable elastic member 34, while the elastic member fixed surface 33 is to fix the elastic member 3; and a displacement sensor 4 is configured to detect a displacement of a side face 35 on the first elastic displacement end 31, and the displacement sensor 4 is located in a fixed place, wherein the first elastic displacement end 31 and the second elastic displacement end 32 go upside and downside deviation relative to the second guiding components 2; wherein the movable elastic member 34 is used for fixing the first elastic displacement end 31, so as to keep the shape of the side face 35 without bending or inclined deformation, the side face 35 is having a parallel displacement relative to the first elastic displacement end 31, and the side face 35 is having a parallel displacement relative to the displacement sensor 4 without any angular displacement. (As shown in FIG. 4)

Preferably, in the first example of the present invention, device 100 for detecting thickness and thickness variation of a sheetlike object 200, the first guiding component 1 and the second guiding components 2 are rollers, the rollers of the second guiding components 2 and the rollers of the first guiding component 1 and are parallel arranged.

Preferably, in the first example of the present invention, device 100 for detecting thickness and thickness variation of a sheetlike object 200, the elastic member 3 is an electric conductor, and the side face 35 is an electric conductor face.

Preferably, in the first example of the present invention, device 100 for detecting thickness and thickness variation of a sheetlike object 200, the first elastic displacement end 31 and the second elastic displacement end 32 of the elastic member are directly or indirectly rigidly connected with the second guiding component 2 respectively, and the displacement of the second guiding component 2 induce the displacement of the first elastic displacement end 31 and the second elastic displacement 32 end synchronously. (As shown in FIG. 4)

Preferably, in the first example of the present invention, device 100 for detecting thickness and thickness variation of a sheetlike object 200, the first guiding components 1 are arranged side by side, and the first guiding components 1 and the second guiding components 2 compose component pairs respectively.

Preferably, in the first example of the present invention, device 100 for detecting thickness and thickness variation of a sheetlike object 200, the displacement sensor 4 includes a plurality of flat coil 41, and the second guiding components 2 are having another flat coil 41 respectively, and a component is set up for inspiring the flat coils 41 to generate alternating magnetic field.

Preferably, in the first example of the present invention, device 100 for detecting thickness and thickness variation of a sheetlike object 200, further comprises an arithmetic unit 42 used for calculating the effect of the side face 35 of first elastic displacement end 31 on the alternating magnetic field of flat coils 41.

Preferably, in the first example of the present invention, device 100 for detecting thickness and thickness variation of a sheetlike object 200, the flat coils 41 are air-cored coils.

Preferably, in the first example of the present invention, device 100 for detecting thickness and thickness variation of a sheetlike object 200, the side face 35 in alternating magnetic field of flat coils 41 existing area is not having any other magnetic material.

In the first example of the present invention, device 100 for detecting thickness and thickness variation of a sheetlike object 200, wherein the elastic membrane 3 is having two surfaces on the first elastic displacement end 31 and the second elastic displacement end 32 connected with both sides of movable elastic member 34 (please refer to FIG. 3 and FIG. 4), wherein the elastic member 3 is forming a U shape and having two curve generally, and the first elastic displacement end 31 and the second elastic displacement end 32 is fixed on the side of movable elastic member 34 respectively.

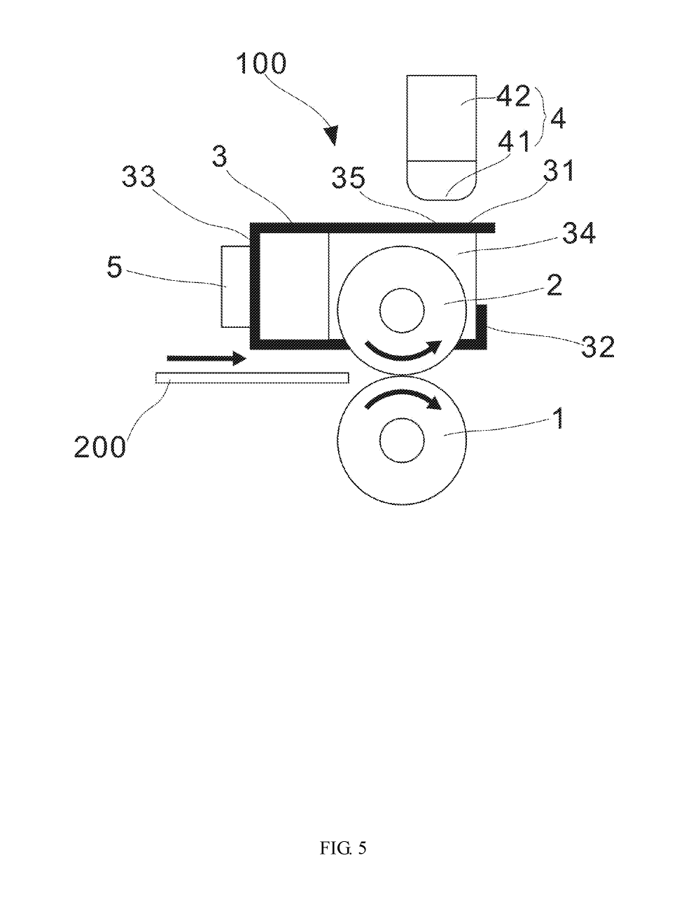

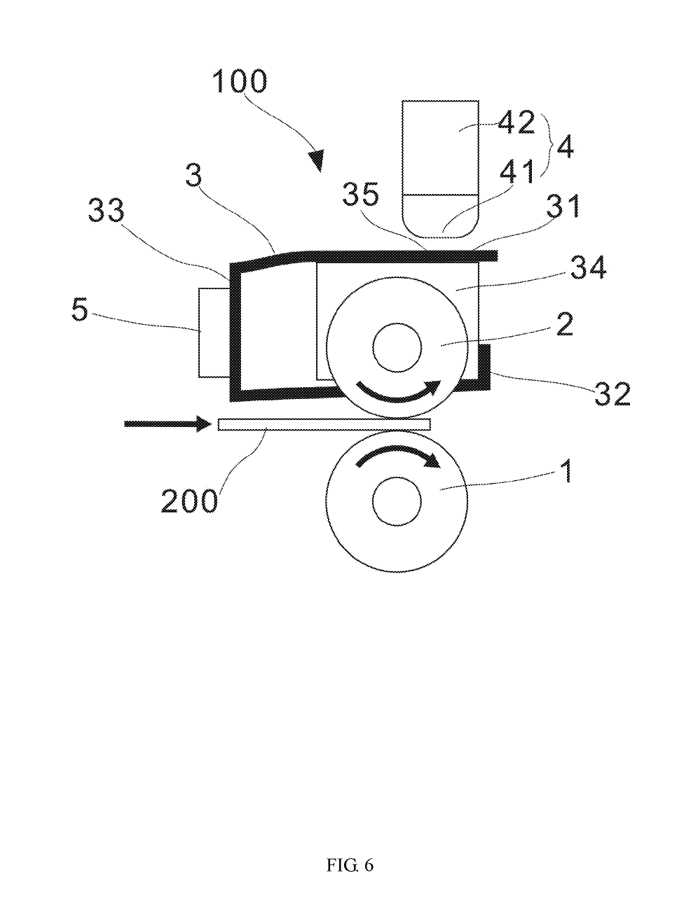

The second example of the present invention is shown as FIG. 5 and FIG. 6, which is a device 100 for detecting thickness and thickness variation of a sheetlike object 200. The difference between example 1 and example 2 is the shape of elastic membrane 3. In the elastic member 3 of example 2, the U shape of elastic membrane 3 is having a extension segment on one end and forming three curves. The first elastic displacement end 31 and the second elastic displacement end 32 connected with both vertical sides of movable elastic member 34, which could keep the shape of the side face 35 without bending or inclined deformation, the side face 35 is having a parallel displacement relative to the first elastic displacement end 31, and the side face 35 is having a parallel displacement relative to the displacement sensor 4 without any angular displacement. (As shown in FIG. 5 and FIG. 6)

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

What is claimed is:

1. A device for detecting thickness and thickness variation of a sheetlike object, includes:
at least a first guiding component and a plurality of second guiding components, wherein the second guiding components are opposite of first guiding component, and the second guiding components are arranged in line, a deviation between the first guiding component and the second guiding components occurs while the sheetlike object passed through the first guiding component and those second guiding components, due to the thickness variation of the sheetlike object;
a elastic member, having a first elastic displacement end, a second elastic displacement end and a elastic member fixed surface, both of the first elastic displacement end and the second elastic displacement have a plane disposed thereto and served to connect with each side of a movable elastic member, while the elastic member fixed surface is to fix the elastic member; and
a displacement sensor is configured to detect a displacement of a side face on the first elastic displacement end, and the displacement sensor is located in a fixed place, wherein the first elastic displacement end and the second elastic displacement end go upside and downside deviation relative to the second guiding components;
wherein the movable elastic member is used for fixing the first elastic displacement end, so as to keep the shape of the side face without bending or inclined deformation, the side face is having a parallel displacement relative to the first elastic displacement end, and the side face is having a parallel displacement relative to the displacement sensor without any angular displacement.

2. The device of claim 1, wherein the first guiding component and the second guiding components are rollers, the rollers of the second guiding components and the rollers of the first guiding component and are parallel arranged.

3. The device of claim 1, wherein the elastic member is an electric conductor, and the side face is an electric conductor face.

4. The device of claim 1, wherein the first elastic displacement end and the second elastic displacement end of the elastic member are directly or indirectly rigidly connected with the second guiding component respectively, and the displacement of the second guiding component induce the displacement of the first elastic displacement end and the second elastic displacement end synchronously.

5. The device of claim 1, wherein the first guiding components are arranged side by side, and the first guiding components and the second guiding components compose component pairs respectively.

6. The device of claim 1, wherein the displacement sensor includes a plurality of flat coils, and the second guiding components are having another flat coils respectively, and an component is set up for inspiring the flat coils to generate alternating magnetic field.

7. The device of claim 1, which further comprises an arithmetic unit used for calculating the effect of the side face of first elastic displacement end on the alternating magnetic field of flat coils.

8. The device of claim 6, wherein the flat coils are air-cored coils.

9. The device of claim 8, wherein the side face in alternating magnetic field of flat coils existing area is not having any other magnetic material.
